(19) United States
(12) Patent Application Publication
(10) Pub. No.: US 2012/0186247 A1
(43) Pub. Date: Jul. 26, 2012

(54) Turbocharger with Reversed Compressor Volute Optionally Integrated into the Center Housing

(75) Inventors: Manuel Marques, (US); Alain Lombard, (US); Jean-Jacques Laissus, (US)

(73) Assignee: Honeywell International Inc.

(21) Appl. No.: 13/014,503

(22) Filed: Jan. 26, 2011

(51) Int. Cl. F02C 6/12

(52) U.S. Cl. 60/605.1

(57) ABSTRACT

A turbocharger includes a single-stage compressor formed by a single centrifugal compressor wheel in a compressor housing, a turbine formed by a turbine wheel in a turbine housing, and a center housing disposed between the compressor and turbine housings. The compressor includes a volute that receives pressurized air, via a diffuser, from the compressor wheel for onward delivery to an air intake of an engine. In one embodiment the compressor volute is reversed relative to a conventional location, such that the volute is displaced to the turbine side of the diffuser rather than to the compressor side. In another embodiment the compressor volute (whether reversed or not) is integrated into the center housing and accordingly the compressor housing is a simple cap having a tubular portion that defines an inlet to the compressor and a flange portion that connects to the center housing.

### BACKGROUND OF THE INVENTION

The present disclosure relates to exhaust gas-driven turbochargers.

In a typical turbocharger there is a compressor housing, a center housing, and a turbine housing. The compressor housing defines a volute that collects pressurized air from the compressor wheel for onward delivery to the air intake of an internal combustion engine. The center housing's main role is to house bearings for the shaft that connects the compressor wheel to the turbine wheel. The turbine housing defines a volute that receives exhaust gas from the engine and directs it into the turbine wheel, which is thereby driven to rotate and drive the compressor wheel.

Each of the three housings has a relatively complicated shape and therefore casting has been the only viable method for manufacturing these housings. The configurations of the compressor and turbine housings furthermore tend to be application-specific, i.e., for each customer application, custom-designed compressor and turbine housings are required.

It would be desirable to have a turbocharger with a simplified design that uses to a greater extent parts that are more generally applicable to a variety of customer applications.

### BRIEF SUMMARY OF THE DISCLOSURE

The present disclosure describes such a simplified turbocharger design. In a conventional compressor housing, the compressor volute is located on the compressor side of the diffuser through which the pressurized air is led into the volute, and accordingly the compressor volute is part of the cast compressor housing. This design has been essentially standard for many decades.

In contrast, the turbocharger described herein, in one embodiment, employs a substantially different design in which the compressor volute is “reversed” so that it is located on the turbine side of the diffuser. The reversed compressor volute optionally can be integrated into the center housing rather than the compressor housing.

Locating the compressor volute on the turbine side of the diffuser permits a substantial reduction in the overall axial length of the turbocharger (particularly at the critical location of the maximum volute projection) relative to an otherwise similar turbocharger having the conventional configuration. This can have significant benefits in terms of “packaging” of the turbocharger in an engine compartment where space is at a premium.

Additionally, when the compressor volute is integrated into the center housing, the compressor housing is substantially simplified and therefore there is increased design flexibility for the compressor housing. For example, the compressor housing can be made from a different (less costly) material from the typical or conventional materials that are used because there is no longer a need for the compressor housing to tolerate the elevated temperature that a conventional compressor housing is subjected to in operation. As an example, the compressor housing could be made of plastic.

Additionally, the design described herein makes it possible to manufacture such a simplified compressor housing by processes cannot be used to make a conventional compressor housing. For instance, the simplified compressor housing can be made by simple die casting, or by machining.

It is also possible to integrate the compressor housing into the air inlet pipe that delivers the pressurized air to the engine.

A further benefit of the design described herein is that the center housing with integrated compressor volute can be a common or standard part that can be applied to a variety of different applications, because all application-specific features (e.g., actuator bracketing, fittings, etc.) can be part of the compressor housing.

The present disclosure also describes another embodiment in which the compressor volute is integrated into the center housing but is not necessarily “reversed” as described above. For example, the compressor volute may be generally symmetrical about the diffuser (i.e., some of the volute is to the compressor side of the diffuser and the rest of the volute is to the turbine side of the diffuser). This embodiment still offers some axial length reduction of the turbocharger, although not as much as the reversed volute configuration, and also allows the center housing to be a common or standard part as described above.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is an axial cross-sectional view of a turbocharger in accordance with one embodiment of the invention; and

FIGS. 2A and 2B illustrate the axial length reduction resulting from reversing the compressor volute in accordance with the invention, wherein FIG. 2A shows a prior-art turbocharger having a conventional compressor volute and FIG. 2B is identical to FIG. 1.

### DETAILED DESCRIPTION OF THE DRAWINGS

The present disclosure now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

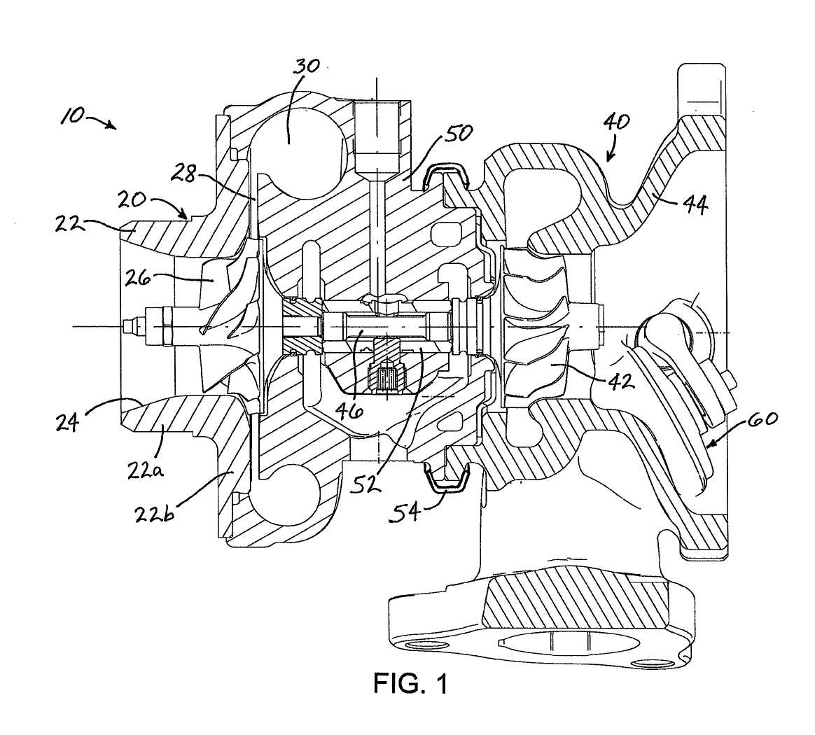

FIG. 1 shows an axial cross-sectional view of a turbocharger 10 in accordance with one embodiment of the present invention. The turbocharger 10 includes a single-stage centrifugal compressor 20 comprising a compressor housing 22 that defines an air inlet 24, a single centrifugal compressor wheel 26 mounted within the compressor housing to receive air from the air inlet, a diffuser 28 that receives pressurized air from the compressor wheel and leads the pressurized air radially outwardly while diffusing the pressurized air, and a compressor volute 30 that collects the diffused, pressurized air from the diffuser for onward delivery to an air intake of an internal combustion engine. In the present description and the appended claims, a “downstream direction” is defined as the direction in which the air travels through the air inlet 24 to the compressor wheel 26 (i.e., left-to-right in FIG. 1).

The turbocharger further includes a turbine 40 comprising a turbine wheel 42 mounted within a turbine housing 44 and connected to the compressor wheel 26 by a shaft 46 that extends along a turbocharger axis about which the shaft rotates, and a center housing 50 connected between the compressor housing 22 and the turbine housing 44. The center housing contains bearings 52 for the shaft 46. There is a wastegate or bypass valve 60 that allows exhaust gas to bypass the turbine wheel 42 when the wastegate is open.

The compressor housing 22, center housing 50, and turbine housing 44 comprise three separately formed parts secured to one another by fastening devices 54.

In accordance with the invention, the compressor volute 30 is displaced in the downstream direction from the diffuser 28. Herein, “displaced in the downstream direction from the diffuser” means that none of the compressor volute 30 is located upstream of (i.e., to the left of, in FIG. 1) the diffuser 28.

In one embodiment as illustrated in FIG. 1, the compressor volute 30 is integrated into the center housing 50. As a result, the compressor housing 22 can be formed as a simple “cap” (also referred to herein as a “compressor inlet cap”) having a tubular portion 22a that defines the air inlet 24 and a flange portion 22b that extends radially outwardly from the tubular portion and that is connected to the center housing 50 (e.g., by threaded fasteners). The diffuser 28 is defined between a surface of the flange portion 22b and a surface of the center housing 50.

The center and turbine housings generally would comprise cast metal parts. In a conventional turbocharger, the compressor housing likewise is usually a cast metal part, but when the compressor volute 30 is “reversed” in accordance with the present invention so that the compressor housing becomes a simple cap, the cap can be formed by simpler means and/or from less-costly materials. For example, the cap can comprise a die-cast metal part. Alternatively the cap can be a machined metal part. The cap can even be a molded plastic part in some cases.

The simple design of the compressor inlet cap allows the possibility of including a variable-geometry device in the cap.

It is also possible to integrate the cap into the air inlet pipe coming from the engine.

In one embodiment, all application-specific features (e.g., actuator bracketing, fittings, etc.) are on the compressor inlet cap. Consequently, the center housing 50 with integrated compressor volute 30 can be a standard part that is used for multiple applications.

The center housing 50 with integrated compressor volute 30 can be manufactured of aluminum or other material.

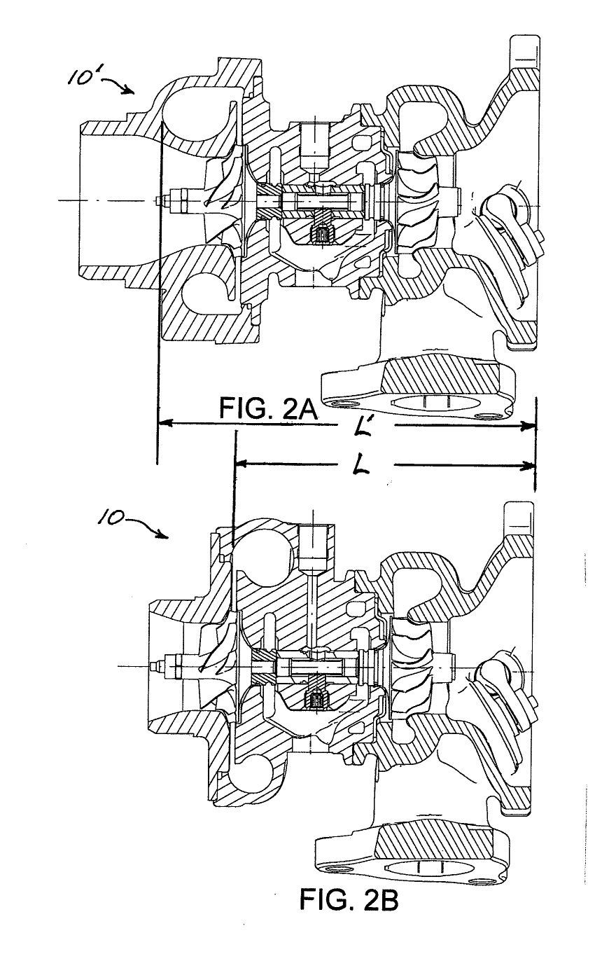

FIGS. 2A and 2B illustrate an axial length reduction of the turbocharger 10 made possible by the reversed volute in accordance with the invention. FIG. 2A shows a prior art turbocharger 10′ that is identical to the turbocharger 10 except that the compressor volute is in the conventional position. It can be seen that at the location of the maximum axial projection of the compressor volute the length L of the turbocharger 10 is substantially smaller than the equivalent length L′ of the conventional turbocharger 10′. Being more compact in this area facilitates the location of the actuator for the wastegate 60. This is an important point, as actuators for typical turbochargers are becoming increasingly larger because of a trend toward higher valve preloads in the closed valve position, and also because increasingly there is a desire to employ electric actuators rather than the more-conventional pneumatic actuators, and electric actuators tend to be larger than equivalent pneumatic ones. This increased actuator size often leads to problems installing the actuator in a given engine layout where space is at a premium. To deal with this issue, frequently technical compromises are made in the actuator mechanical installation. The significant axial length reduction made possible by the invention makes it easier to employ a larger actuator while not having to make compromises in its installation.

The embodiment described above has the compressor volute 30 integrated into the center housing 50. Alternatively, in accordance with another embodiment of the invention, the reversed compressor volute can be integrated into the compressor housing rather than the center housing. This embodiment is less preferred that the previously described one, however, because it does not result in substantial simplification of the compressor housing relative to a conventionally designed compressor housing.

A further embodiment of the invention provides a turbocharger in which the compressor volute is integrated into the center housing but is not necessarily “reversed” as described above. For example, the compressor volute may be generally symmetrical about the diffuser (i.e., some of the volute is to the compressor side of the diffuser and the rest of the volute is to the turbine side of the diffuser). This embodiment still offers some axial length reduction of the turbocharger, although not as much as for the reversed-volute configuration, and also allows the center housing to be a common or standard part as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A turbocharger comprising:
a single-stage centrifugal compressor comprising a compressor housing that defines an air inlet, a single centrifugal compressor wheel mounted within the compressor housing to receive air from the air inlet, a diffuser that receives pressurized air from the compressor wheel and leads the pressurized air radially outwardly while diffusing the pressurized air, and a compressor volute that collects the diffused, pressurized air from the diffuser for onward delivery to an air intake of an internal combustion engine;
a turbine comprising a turbine wheel mounted within a turbine housing and connected to the compressor wheel by a shaft that extends along a turbocharger axis about which the shaft rotates;
a center housing connected between the compressor housing and the turbine housing, the center housing containing bearings for the shaft;
the compressor, center, and turbine housings comprising three separately formed parts secured to one another by fastening devices;
wherein a downstream direction is defined as the direction in which the air travels through the air inlet to the compressor wheel; and
wherein the compressor volute is displaced in the downstream direction from the diffuser.

2. The turbocharger of claim 1, wherein the compressor volute is integrated into the center housing and the compressor housing comprises a simple cap, the cap having a tubular portion that defines the air inlet and a flange portion that extends radially outwardly from the tubular portion and connects to the center housing.

3. The turbocharger of claim 2, wherein the diffuser is defined between a surface of the flange portion and a surface of the center housing.

4. The turbocharger of claim 2, wherein the center and turbine housings comprise cast metal parts and the cap comprises a die-cast metal part.

5. The turbocharger of claim 2, wherein the center and turbine housings comprise cast metal parts and the cap comprises a plastic part.

6. The turbocharger of claim 2, wherein the center and turbine housings comprise cast metal parts and the cap comprises a machined metal part.

7. The turbocharger of claim 2, further comprising an air inlet pipe that supplies the pressurized air to the air intake of the engine, and wherein the cap is integrated into the air inlet pipe.

8. The turbocharger of claim 1, wherein the compressor volute is integrated into the compressor housing.

9. A turbocharger comprising:
a single-stage centrifugal compressor comprising a compressor housing that defines an air inlet, a single centrifugal compressor wheel mounted within the compressor housing to receive air from the air inlet, a diffuser that receives pressurized air from the compressor wheel and leads the pressurized air radially outwardly while diffusing the pressurized air, and a compressor volute that collects the diffused, pressurized air from the diffuser for onward delivery to an air intake of an internal combustion engine;
a turbine comprising a turbine wheel mounted within a turbine housing and connected to the compressor wheel by a shaft that extends along a turbocharger axis about which the shaft rotates;
a center housing connected between the compressor housing and the turbine housing, the center housing containing bearings for the shaft;
the compressor, center, and turbine housings comprising three separately formed parts secured to one another by fastening devices;
wherein a downstream direction is defined as the direction in which the air travels through the air inlet to the compressor wheel; and
wherein the compressor volute is integrated into the center housing.

10. A turbocharger comprising:
a shaft rotatably supported in bearings, a compressor wheel affixed to one end of the shaft, and a turbine wheel affixed to an opposite end of the shaft;
a bearing housing that houses the bearings;
a diffuser for receiving and diffusing the compressed air from the compressor wheel and supplying the compressed air to a compressor volute; and
a cap formed separately from the housing and removably secured to the housing;
wherein the compressor volute is located on a turbine side of the diffuser, one wall of the diffuser is defined by the cap, and an opposite wall of the diffuser is defined by the bearing housing.

11. The turbocharger of claim 10, wherein the compressor volute is defined in the bearing housing.

12. The turbocharger of claim 10, wherein the cap includes a tubular portion that defines an inlet for the compressor wheel and a flange portion extending radially outwardly from the tubular portion, and wherein the one wall of the diffuser is defined by the flange portion of the cap.
